(19) United States
(12) Patent Application Publication
(10) Pub. No.: US 2010/0269367 A1
(43) Pub. Date: Oct. 28, 2010

(54) DEVICE FOR BLOWING GAS ONTO A FACE OF A TRAVELING STRIP OF MATERIAL

(76) Inventors: Stephane Langevin, Saint-Fargeau-Ponthierry (FR); Patrick Dubois, Andrezel (FR)

Correspondence Address: Muncy, Geissler, Olds & Lowe, PLLC, 4000 Legato Road, Suite 310, FAIRFAX, VA, 22033, US

(21) Appl. No.: 12/746,872

(22) PCT Filed: Dec. 17, 2008
(86) PCT No.: PCT/FR2008/001761

§ 371 Date: Jun. 8, 2010

(30) Foreign Application Priority Data
Dec. 28, 2007 (FR) 07 09166
Oct. 22, 2008 (FR) 08 05843

(51) Int. Cl. F26B 19/00

(52) U.S. Cl. 34/611

(57) ABSTRACT

A gas blower device for blowing gas onto a face of a traveling strip of material. The device has at least one hollow box fitted with a plurality of tubular nozzles pointing towards the face in question of the strip of material. On the side facing towards the face in question of the strip of material, the hollow box presents a surface of profile (P) that varies in at least one given direction (D) symmetrically about a midplane (Q) perpendicular to the plane of the strip. The tubular nozzles are fastened via their roots to the varying-profile surface in such a manner that their respective axes are essentially orthogonal to said varying profile at the point in question, said tubular nozzles having respective lengths that are selected so that the outlet orifices lie in a common plane substantially parallel to the plane of the strip.

The present invention relates to a gas blower device for blowing gas onto a surface of a traveling strip of material. The invention relates particularly to processing lines for processing strips of steel or aluminum by using at least one cooling chamber for cooling by means of gas jets, or one cooling section for cooling by means of gas jets, such as thermal processing lines, in particular continuous annealing lines, or such as coating lines, in particular galvanization lines.

However, the invention is not limited to the above-mentioned field of use and relates more generally to blowing gas onto a face of a traveling strip of material that may be a non-metallic material, e.g. paper, or a plastics material, with a view to a drying, cooling, or coating, depending on the circumstances.

### BACKGROUND OF THE INVENTION

For a long time it has been known to use gas blower devices for blowing gas onto one or two faces of a traveling strip of metal, in particular with a view to cooling said strip. Reference may thus be made to documents U.S. Pat. No. 3,116,788 and U.S. Pat. No. 3,262,688 that describe various systems for blowing gas from hollow boxes or tubular hollow elements disposed in the longitudinal direction of the strip or in a transverse direction across the travel direction of said strip. Those documents teach the use of gas jets that are sloping relative to normal to the plane of the traveling strip so as to improve the stability of the traveling strip.

Reference may also be made to documents GB-A-940 881, DE-A-4 406 846, FR-A-1 410 686 and WO-A-2007/014406 that describe blower boxes having perforated active faces.

Proposals have also been made for assemblies having two cooling tubes of slope that is adjustable relative to the plane of the strip, as described in documents JP-A-58 185 717 and JP-A-58 157 914.

More recently, proposals have been made to channel the stream of blown gas by providing boxes fitted with blower tubes, with the blower tubes sloping towards the edges of the strip, mainly in order to avoid causing the traveling strip to vibrate while it is being cooled by blown gas jets, as described in document WO-A-01/09397.

Document U.S. Pat. No. 6,054,095 also teaches sloping blower tubes provided in the boxes towards the edges of the strip, the arrangement of the blower tubes being chosen in order to improve temperature uniformity of the strip.

The above-mentioned gas blower devices thus comprise two hollow boxes each provided with a plurality of tubular nozzles directed towards the face in question of the strip of material, each hollow box presenting, from the side turned towards the face in question of the strip of material, a flat profile that is parallel to the plane of the strip.

In the above-mentioned devices, the orifices of the tubular nozzles are at a distance from the strip that is sufficient to avoid any risk of contact with said strip, which would risk marking the strip of material and damaging it, or possibly tearing off the tubular blower nozzles. Thus, in practice, even with the blower nozzle systems sloping towards the edges of the strip, the distance between the orifices of the blower nozzles and the strip is rarely less than a distance of 50 millimeters (mm) to 100 mm.

In order to improve cooling performance, it is necessary either to reduce said distance in substantial manner, or else to organize the blower system so as to have very high flow rates, which leads to high cost, or indeed to adopt both of the above-mentioned solutions, but that further increases the risk of contact between the strip and the blower nozzles because of the difficult-to-control oscillations of the strip while said strip is traveling. Therefore, in practice a structural limit is encountered that is commonly accepted by specialists in the field.

The technological background may be concluded by mentioning document JP-A-2005 089772, which describes a v-shaped sprinkler tube fitted with tubular nozzles, all having the same length, and spraying cooling water onto a vertical strip of steel.

### OBJECT OF THE INVENTION

The invention aims to provide a gas blower device that does not present the drawbacks and/or limitations of the above-mentioned prior art systems, and that optimizes both the thermal and air-flow aspects of blowing, while minimizing the vibration or offsets of the strip while it is traveling, and to do this with an installation of cost that is reasonable.

### GENERAL DESCRIPTION OF THE INVENTION

The above-mentioned technical problem is solved in accordance with the invention by means of a gas blower device for blowing gas onto a face of a traveling strip of material, the device comprising at least one hollow box fitted with a plurality of tubular nozzles pointing towards the face in question of the strip of material, in which the hollow box presents a surface of profile that varies in at least one given direction symmetrically about a midplane perpendicular to the plane of the strip, and the tubular nozzles being fastened via their roots to the varying-profile surface in such a manner that their respective axes are essentially orthogonal to said varying profile at the point in question, the tubular nozzles having respective lengths that are selected so that the outlet orifices of said nozzles lie in a common plane substantially parallel to the plane of the strip.

Because a varying profile is organized for the active surface(s) of the hollow box(es), a very substantial improvement can be obtained in recirculating the gas, without however making implementation of the tubular nozzles more complicated, since they continue to be implanted with their axes orthogonal relative to the surface carrying them, and in addition the arrangement of the nozzles with their lengths adapted to the varying profile guarantees excellent uniformity of blowing, and thereby obtaining significant advantages both for the uniformity of the temperature of the strip of material and for the stability of said strip of material while it is traveling, and whatever the varying profile used.

The given direction in which the profile varies may extend transversely to the travel direction of the strip of material, or in a variant parallel thereto. In another variant, the profile could vary both in a direction that extends transversely to the travel direction of the strip of material and in a direction that extends parallel to said travel direction.

Preferably, the varying profile is a dihedral profile so as to confer constant slope to the tubular nozzles on either side of the midplane. The above-mentioned dihedral profile may be of convex type or of concave type, such that the middle ridge of the varying-profile surface thus corresponds respectively to the smallest or greatest distance from the plane of the strip as a function of the desired technical effect for the application in question. In particular, provision may be made for the dihedral profile to present an angle at the apex lying in the range 150° and 170°.

In a variant of the dihedral varying profile, provision may be made for a broken-line profile, or a curvilinear profile thereby conferring varying slope to the tubular nozzles on either side of the midplane.

Also preferably, it is advisable to provide for the varying-profile surface to present, on the inside of the hollow box and in association with the root of each tubular nozzle, a bell-mouth shaped orifice, and for each tubular nozzle to present a free end with a conically flaring bore, these features procuring substantial advantages given the reduction of head loss. This thus makes it possible to use a very large number of blower nozzles with a view to obtaining good efficiency both thermally and in terms of air flow, while using a reasonable level of power.

In accordance with a particularly advantageous embodiment, the gas blower device has two hollow boxes between which the strip of material is designed to travel, such that gas is blown simultaneously onto both faces of the traveling strip, and at least one of said boxes has a surface of varying profile for implanting the associated tubular nozzles.

The two hollow boxes then preferably have respective surfaces of varying profile, and these two surfaces are symmetrical about the travel plane of the strip.

Finally, provision may also be made for the tubular nozzles of the two hollow boxes to be implanted in such a manner that the points of impact of the gas blown onto the traveling strip are in a configuration that is staggered on opposite sides of said strip when the given direction in which the profile varies extends transversely to the travel direction of the strip of material. For a direction that is parallel to the travel direction, provision may also be made for the points of impact of the gas blown onto the traveling strip to be in a configuration that is staggered lengthwise along said strip, and for a profile varying both in a direction extending transversely to and in a direction parallel to the travel direction, provision may be made for a configuration that is staggered crosswise and lengthwise across and along said strip.

Other characteristics and advantages of the invention appear more clearly in light of the description given below and the accompanying drawings.

### BRIEF DESCRIPTION OF THE DRAWINGS

Reference is made below to the accompanying drawings, in which:

FIG. 1 is a perspective view of a gas blower device of the invention, this embodiment including two hollow boxes between which a strip of material travels, each hollow box having an active surface fitted with tubular nozzles and presenting a varying profile forming a convex dihedral ridge extending in a transverse direction across the travel direction of the strip of material;

FIG. 2 is a plan view of the device of FIG. 1, showing more clearly the two facing surfaces having varying profiles in the form of convex dihedral ridges;

FIG. 3 is a side view of the device of FIG. 1;

FIG. 4 is a view of the active surface of one of the hollow boxes, which surface is fitted with a plurality of tubular nozzles and presents a varying profile, in this embodiment of dihedral shape and showing the middle ridge;

FIG. 5 is a fragmentary view of two boxes of the above-described blower device, showing more clearly the two facing convex dihedral profiles;

FIGS. 6 and 7, corresponding to FIG. 5, show two other variants in which respectively one of the boxes presents an active surface of conventional type (plane face), or both boxes have an active surface presenting a dihedral profile that is no longer of convex type but of concave type;

FIG. 8 is a fragmentary view on a larger scale showing more clearly the arrangement of the tubular nozzles, and in particular the staggered arrangement of their points of impact along the traveling strip;

FIG. 9 is a section view of a tubular nozzle, showing more clearly the shape and the implantation of a said nozzle with a view to minimizing the head losses;

FIGS. 10 and 11 are fragmentary views corresponding to those of FIG. 8, intended to show other types of varying profile, in this embodiment respectively a broken-line profile and a curvilinear profile, in order to confer varying slope to the tubular nozzles; and

FIGS. 12 and 13, are similar to FIGS. 1 and 2, and show a variant in which the direction in which the profile varies is parallel to the travel direction of the strip of material, and FIGS. 14 and 15 show in the same way another variant in which the profile varies both in a transverse direction and in a direction parallel to said travel direction.

### DETAILED DESCRIPTION OF THE PREFERRED EMBODIMENT OF THE INVENTION

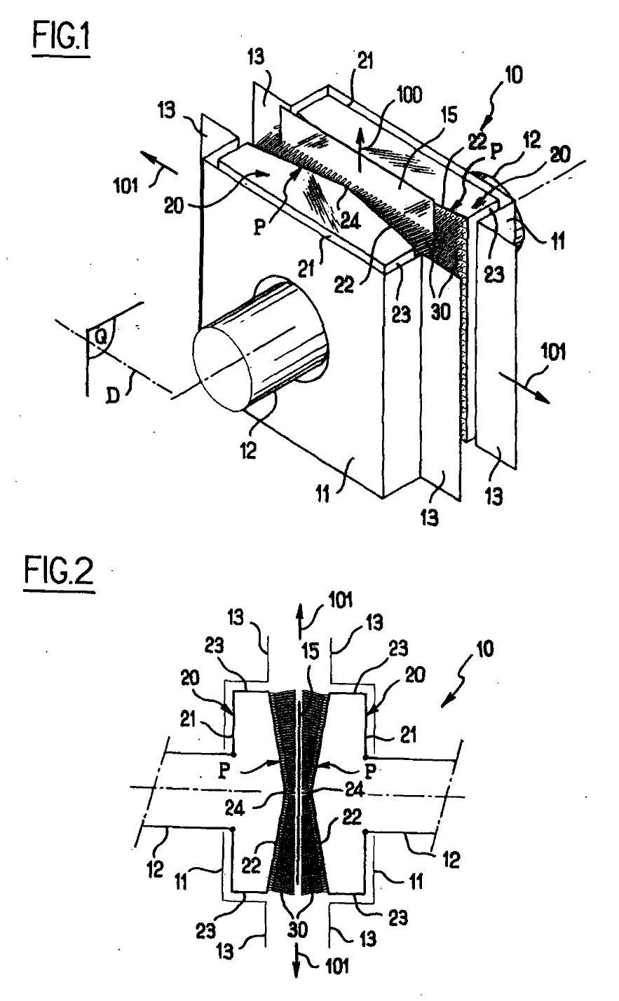

FIGS. 1 to 3 show a portion of a blower installation including a gas blower device in accordance with the invention and given reference 10.

On either side of a traveling strip of material given reference 15, and having a travel direction symbolized by arrow 100, the device 10 comprises structural elements 11, in this embodiment of an omega shape, with margins given reference 13, which elements are fastened to respective hollow boxes 20, the strip 15 of material traveling between the two facing hollow boxes.

Each hollow box 20 has two side faces 23, a back face 21 connected to a blowing gas admission tube 12 and a front or active surface 22, opposite from the face 21, which front surface is turned towards the face in question of the strip of material 15.

Each hollow box 20 is fitted with a plurality of tubular nozzles 30 pointing towards the face in question of the strip of material 15.

In accordance with a characteristic of the invention, the surface 22 of each hollow box 20, that is turned towards the face in question of the strip of material 15, presents a profile P that varies in at least one given direction D, in this embodiment a single direction that extends transversely to the travel direction 100 of the strip of material 15, symmetrically about a midplane Q perpendicular to the plane of the strip 15 (shown more clearly in FIG. 1), and the tubular nozzles 30 are fastened via their roots to the varying-profile surface 22 in such a manner that their respective axes are essentially orthogonal to said varying profile at the point in question (shown more clearly in the detail of FIG. 9). Moreover, the respective lengths l of each of the tubular nozzles 30 are selected so that the outlet orifices of said nozzles lie in a common plane (said common plane, given reference R, is shown more clearly in the detail of FIG. 8) that is substantially parallel to the plane of the strip 15. By means of this arrangement, jet distances are obtained that are identical across the entire width of the strip, and on either side (on each side) thereof, and this is advantageous both for good stabilization while said strip is traveling, and also for the temperature uniformity in said strip. This may seem surprising to the person skilled in the art, since the varying lengths of the tubular nozzles modify the outlet speeds of the blown gas very little (in spite of being long in absolute terms), and it is therefore the equal distances between the nozzle orifices and the plane of the strip that maintain the uniformity of the action exerted by the gas blown onto said strip.

As shown in the implementation visible in FIGS. 1 to 5, the varying profile P is a dihedral profile so as to confer constant slope to the tubular nozzles 30 on either side of the midplane Q, and in this embodiment said dihedral profile is of convex type, such that the middle ridge 24 of the varying-profile surface 22 corresponds to the smallest distance from the plane of the strip 15.

Specifically, use is made of two hollow boxes 20 between which the strip of material 15 can travel, such that gas is blown simultaneously against both faces of the traveling strip 15. In FIGS. 1 to 5, the two hollow boxes 20 have surfaces 22 of varying profile P in a convex dihedral shape, and said two surfaces are symmetrical about the plane of the strip 15. The slope of each face of the dihedral shape is identified by an angle β, and the angle at the apex (obtuse angle) is given reference α. In particular, with an angle β of about 10°, tubular nozzles 30 having a length l lying in the range 250 mm to 300 mm could be provided, the tubular nozzles fastened at the ridge 24 of the dihedron being in this configuration being perpendicular to the plane of the strip, in the midplane Q, with a shorter length l of about 100 mm. The spacing d of the axes 35 of adjacent tubular nozzles 30 (shown more clearly in the detail of FIG. 8) is therefore in the order of 60 mm.

The dihedral profile P of convex type can turn out to be very advantageous when it is sought to encourage recirculation of the blown gas from the side, with the gas escaping sideways along the arrows 101 shown in FIGS. 1 and 5, FIG. 5 showing the divergent effect obtained by the sloping arrangement of the two surfaces 22 on each side of the midplane Q, the diverging corridor naturally favoring good recirculation of blown gas from the side.

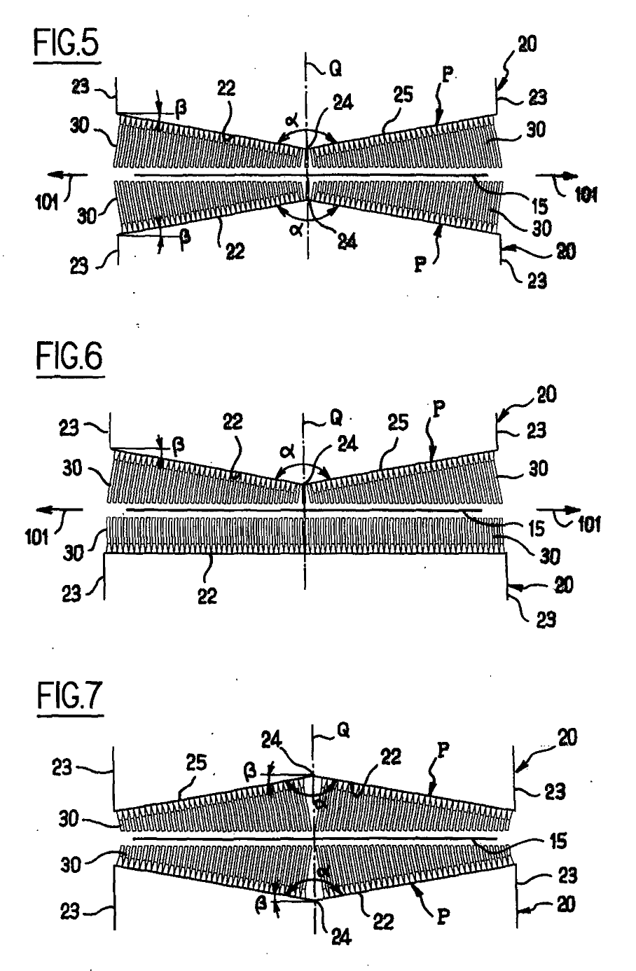

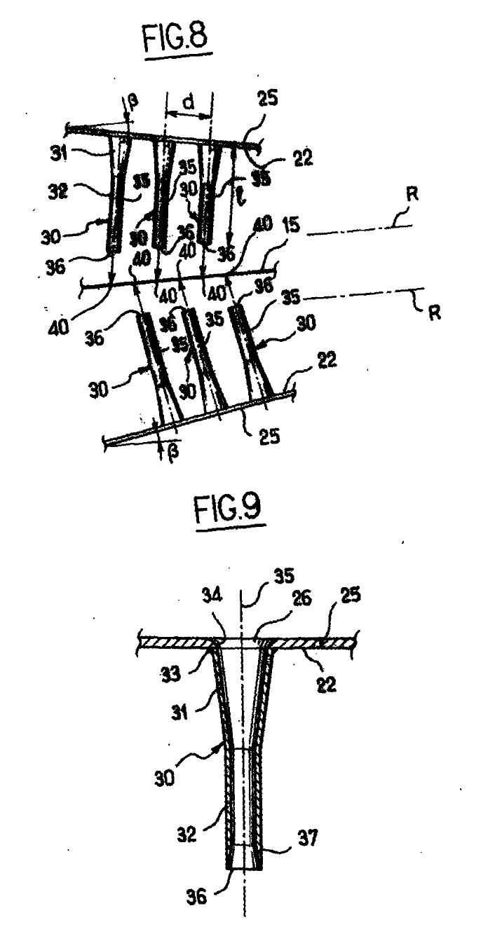

Naturally, in a variant, provision could be made for a different arrangement of the two facing boxes 20, as shown in FIGS. 6 and 7.

In FIG. 6, only one of the boxes 20 presents a surface 22 of varying profile P, in this embodiment a dihedral profile of convex type, whereas the other box 20 is of conventional type, with a surface 22 that is plane and parallel to the plane of the traveling strip 15. The above-mentioned effect of a divergent side recirculation passage is still observed, but the effect is less marked than in the variant of FIG. 5.

In FIG. 7, the two facing boxes 20 present a surface of varying profile P surface that, in this embodiment, is a dihedral profile of concave type, such that the middle groove 24 of the surface of varying profile 22 corresponds to the greatest distance from the plane of the strip 15. This embodiment should be used with moderate blowing powers only, causing fewer problems relating to gas recirculation, and with a view to blowing gas mainly onto the central zone of the traveling strip.

For the varying profiles P of convex or concave dihedral shape in the embodiments shown in FIGS. 5 to 7, the slope relative to the plane of the strip 15, on either side of the midplane Q, corresponds to an angle β having a value generally lying in the range 5° to 15°. This thus corresponds to an angle at the apex of the dihedral profile P, given reference α, having a value lying in the range 150° to 170°.

Due to the axis of each tubular nozzle 30 being orthogonal relative to the dihedral profile, the tubular nozzles 30 have axes that are all parallel to a single direction on either side of the midplane Q.

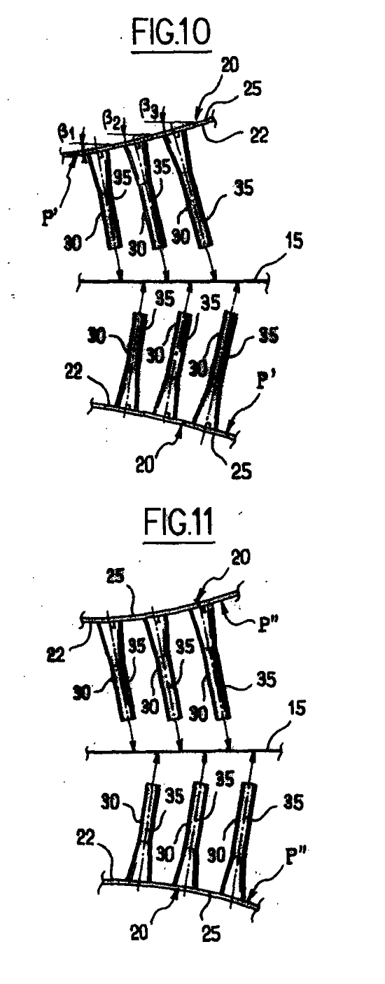

In some circumstances, if it is desired to have a varying slope of the tubular nozzles 30 on either side the midplane Q, on going towards the edges of the traveling strip 15, then provision may be made for other types of varying profile P, such as that shown for example in FIGS. 10 and 11.

FIG. 10 shows a broken-line profile P′ in which there can be seen three adjacent zones, corresponding respectively to angles β1, β2, and β3 relative to the plane of the strip the angles βᵢ preferably increasing on getting closer to the edges of the strip if it is desirable to favor acquiring a divergent effect for favoring good side recirculation of blown gas, as for FIG. 5 with a convex dihedral profile.

FIG. 11 shows another profile P″ that is curvilinear, for example elliptical, with orthogonality being maintained locally at the root of each of the tubular nozzles 30.

FIGS. 8 and 9 provide a better understanding of the implantation and the shape of the tubular nozzles 30 fitted on a hollow box 20 having an active surface 22 that presents a varying profile, and in this configuration, a sloping active surface forming part of a convex dihedral profile.

FIG. 8 shows that the tubular nozzles 30 are implanted in such a manner that the points of impact, given reference 40, of the gas blown onto the traveling strip 15 are in a configuration that is staggered on opposite sides of said strip. Such an arrangement promotes stability of the strip while it is traveling, and also promotes uniform cooling, in lines for cooling a metal strip, by creating adjacent overlapping cooling zones on either side of the traveling strip.

FIG. 9 shows more clearly the base plate 25 of the box 20, with one of its orifices 26 associated with a tubular nozzle 30 having an axis 35 orthogonal to the plane of said base plate 25. Each tubular nozzle 30 is fastened via its root 33, and at said root 33, the orifice 26 presents a bell-mouth shape 34 having a radius selected in order to minimize head loss on passing through the orifice 26. The tubular nozzle 30 itself further comprises an upstream first portion 31 of frustoconical shape that is fastened, in particular welded, to the base plate 25, and a downstream second portion 32 of cylindrical shape, having a free end 37 that is arranged to present an inside bore that flares conically until reaching the outlet orifice 36. By way of example, divergence of about 15° could be chosen. This double flaring of the gas passage confers a nozzle effect that favors the flow of said gas and also makes it possible to minimize head losses.

Provision could further be made for another variant (not shown in the drawings) in which the frustoconical upstream portion 31 is replaced by a bell-mouth or trumpet-shaped portion that is connected tangentially to the cylindrical downstream portion 32, in order to reduce head losses even further.

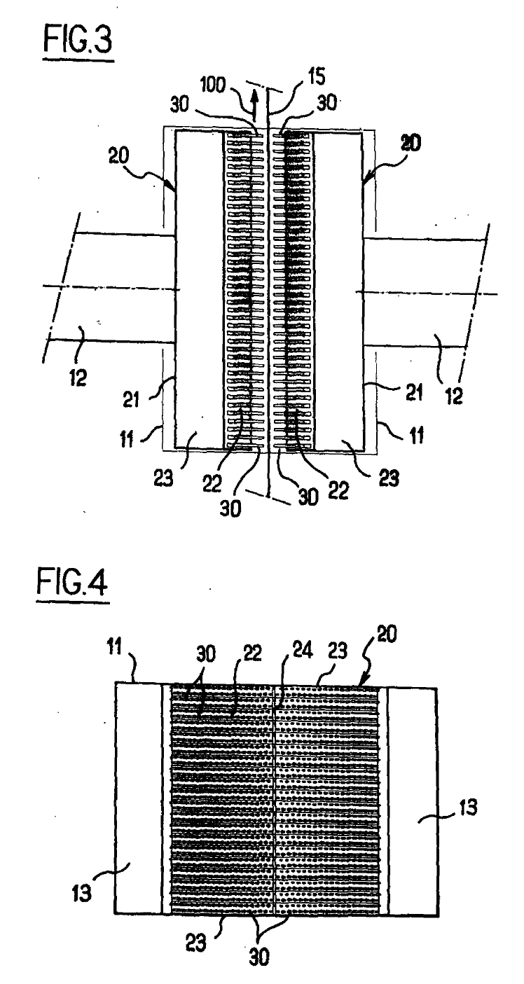

Finally, more generally, the drawings show implantations of tubular nozzles such that the axis of each of said nozzles is also orthogonal to the carrying wall in a longitudinal vertical plane along the direction of the strip (as shown more clearly in FIG. 3). However, in another variant (not shown in the drawings) provision could be made for the axes of certain tubular nozzles, while being essentially orthogonal to the varying profile (i.e. in a direction that extends transversely to the travel direction of the strip), also to present an upstream or downstream slope, relative to the travel direction of the strip. This complicates implementation of the tubular nozzles in question to a greater or lesser extent, but makes it possible to further improve stability of the strip.

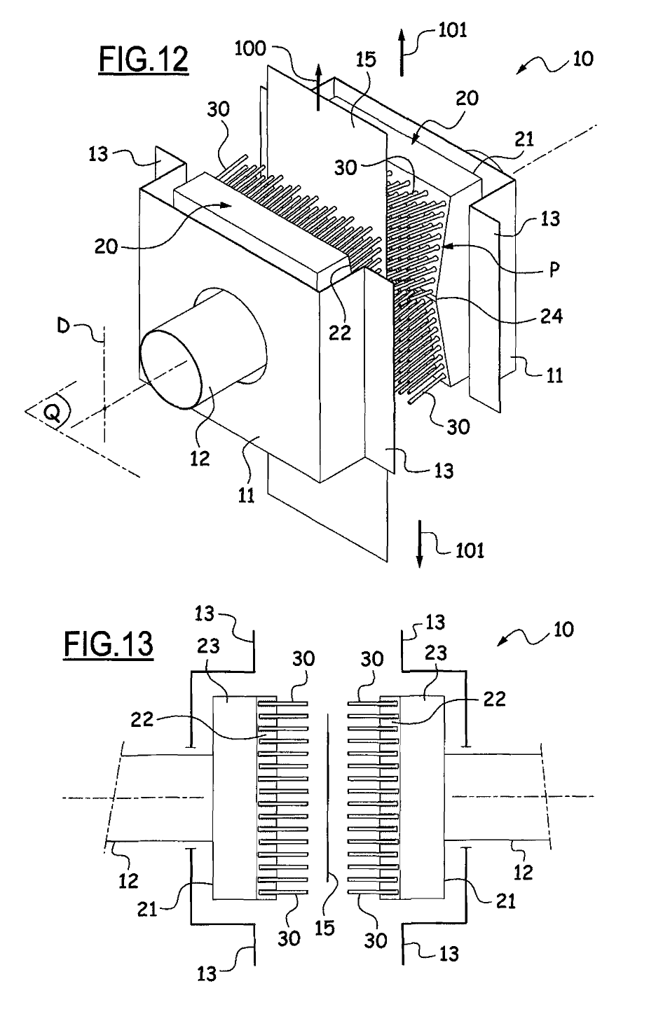

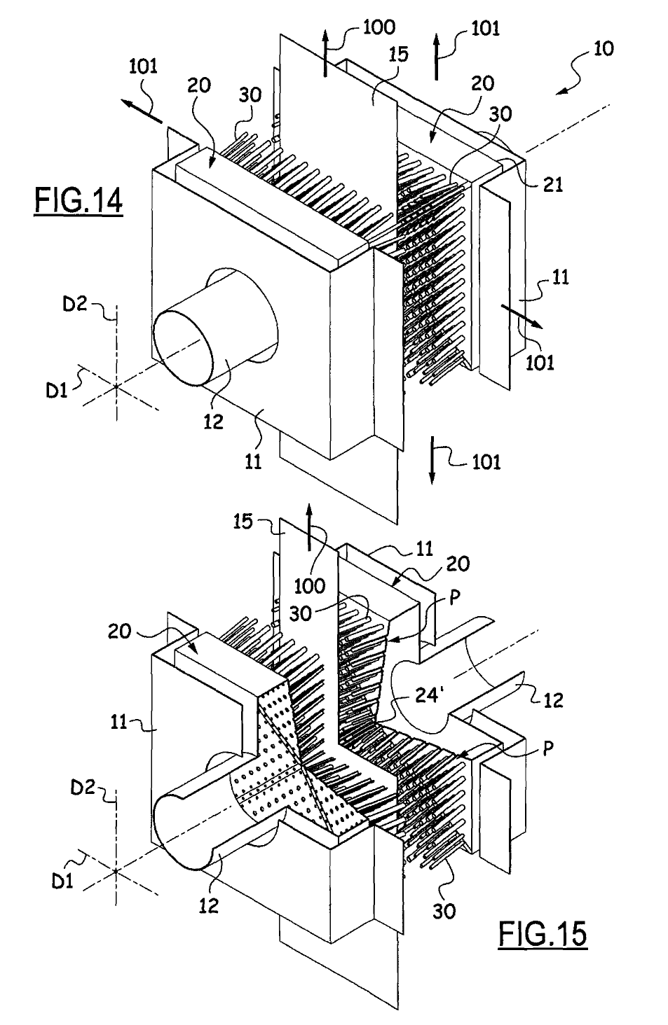

As shown in FIGS. 12 and 13, provision may be made for the direction D in which the profile P varies not to extend transversely to the travel direction of the strip of material 100 as for the above-described variants, but to be parallel to said travel direction. In this configuration, it is above all the air-flow effect that is advantageous, because the device constitutes an excellent longitudinal stabilizer for the traveling strip. Such an arrangement makes it possible to better control the vibration frequencies of the strip. This is particularly advantageous for an application to systems for drying zinc on strips of steel.

In this arrangement the same effect as that shown in FIGS. 8, 10, and 11 may be expected for the points of impact 40 of the gas blown onto the strip, and the configuration is therefore staggered lengthwise relative to said strip.

As shown in FIGS. 14 and 15, use may also be made of hollow boxes having both a profile P that varies in a transverse direction D1 and a profile P that varies in a longitudinal direction D2, e.g. with diamond point faces (point 24′), as shown in the drawings, or with a central platform, and that thus makes it possible to combine the above-mentioned technical effects in both directions of the strip.

It is thus possible to make a high-performance gas blower device that remains simple to manufacture at reasonable cost. The arrangement of the invention also makes it possible to minimize the distance between the strip and the orifices of the tubular nozzles, this distance possibly being, for example, of the order of 50 mm, or sometimes even less for certain sizes. Finally, this arrangement proves to be very favorable with regard to an anti-vibration and self-stabilizing effect for the traveling strip, and this is true even for very high travel speeds.

In addition, it is naturally possible to equip existing installations by replacing the hollow boxes having plane active surfaces with hollow boxes having varying-profile active surfaces of the invention, which makes it possible to obtain the performance of the invention.

As mentioned above, although the preferred field of use is that of lines for cooling or coating a metal strip, the device of the invention may be used with strips of paper, which are more fragile than metal strips, for drying, cooling, or coating treatments.

The invention is not limited to the above-described embodiments, but on the contrary encompasses any variant reproducing the essential characteristics mentioned above, with equivalent means.

What is claimed is:

1. A gas blower device for blowing gas onto a face of a traveling strip of material, the device comprising at least one hollow box fitted with a plurality of tubular nozzles pointing towards the face in question of the strip of material and wherein, on the side facing towards the face in question of the strip of material, the hollow box presents a surface of profile (P) that varies in at least one given direction (D) symmetrically about a midplane (Q) perpendicular to the plane of the strip, and the tubular nozzles are fastened via their roots to the varying-profile surface in such a manner that their respective axes are essentially orthogonal to said varying profile at the point in question, the tubular nozzles having respective lengths (l) that are selected so that the outlet orifices of said nozzles lie in a common plane (R) substantially parallel to the plane of the strip.

2. The gas blower device according to claim 1, wherein the given direction (D) in which the profile (P) varies extends transversely to the travel direction of the strip of material.

3. A gas blower device according to claim 1, wherein the given direction (D) in which the profile (P) varies extends parallel to the travel direction of the strip of material.

4. A gas blower device according to claim 1, wherein the profile (P) varies both in a direction (D1) that extends transversely to the travel direction of the strip of material and in a direction (D2) that extends parallel to said travel direction.

5. A gas blower device according to claim 1, wherein the varying profile (P) is a dihedral profile so as to confer constant slope to the tubular nozzles on either side of the midplane (Q).

6. A gas blower device according to claim 5, wherein the dihedral profile (P) is of convex type, such that the middle ridge of the varying profile surface corresponds to the smallest distance from the plane of the strip.

7. A gas blower device according to claim 5, wherein the dihedral profile (P) is of concave type, such that the middle ridge of the varying profile surface corresponds to the greatest distance from the plane of the strip.

8. A gas blower device according to claim 6, wherein the dihedral profile (P) presents an angle at the apex (α) lying in the range 150° to 170°.

9. A gas blower device according to claim 1, wherein the varying profile (P) is a broken-line profile (P′) or a curvilinear profile (P″), thereby conferring varying slope to the tubular nozzles on either side of the midplane (Q).

10. A gas blower device according to claim 1, wherein the wall of outside surface constituting the varying-profile surface presents, on the inside of the hollow box and in association with the root of each tubular nozzle, a bell-mouth shaped orifice, and each tubular nozzle presents a free end with a conically flaring bore.

11. A gas blower device according claim 1, having two hollow boxes between which the strip of material is designed to travel, such that gas is blown simultaneously onto both faces of the traveling strip, wherein at least one of said boxes has a surface of varying profile (P) for implanting the associated tubular nozzles.

12. A blower device according to claim 11, wherein each of the two hollow boxes has a surface of varying profile (P), and these two surfaces are symmetrical about the travel plane of the strip.

13. A blower device according to claim 11, wherein the given direction (D) in which the profile (P) varies extends transversely to the travel direction of the strip of material, and wherein the tubular nozzles of the two hollow boxes are implanted in such a manner that the points of impact of the gas blown onto the traveling strip are in a configuration that is staggered on opposite sides of said strip.

14. A blower device according to claim 11, wherein the given direction (D) in which the profile (P) varies extends parallel to the travel direction of the strip of material, and wherein the tubular nozzles of the two hollow boxes are implanted in such a manner that the points of impact of the gas blown onto the traveling strip are in a configuration that is staggered lengthwise along said strip.

15. A blower device according to claim 11, wherein the profile (P) varies both in a direction (D1) that extends transversely to the travel direction of the strip of material and in a direction (D2) that extends parallel to said travel direction, and wherein the tubular nozzles of the two hollow boxes are implanted in such a manner that the points of impact of the gas blown onto the traveling strip are in a configuration that is staggered crosswise and lengthwise across and along said strip.
